(19) United States
(12) Patent Application Publication
(10) Pub. No.: US 2023/0162068 A1
(43) Pub. Date: May 25, 2023

(54) DEVICE, METHOD AND NON-TRANSITORY COMPUTER-READABLE MEDIUM FOR MODEL ESTIMATION

(71) Applicant: NEC Corporation, Minato-ku, Tokyo (JP)

(72) Inventors: Yutaka UNO, Singapore (SG); Yew Chong Raymond LEONG, Singapore (SG); Ni Ni SOE, Singapore (SG); Chi Hin Charles CHOY, Singapore (SG)

(73) Assignee: NEC Corporation, Minato-kU, Tokyo (JP)

(21) Appl. No.: 17/917,037

(22) PCT Filed: Apr. 12, 2021
(86) PCT No.: PCT/JP2021/015200

§ 371 Date: Oct. 5, 2022

(30) Foreign Application Priority Data
Apr. 13, 2020 (SG) 10202003373S

(51) Int. Cl. G06N 7/01; G06N 20/00

(52) U.S. Cl. CPC G06N 7/01; G06N 20/00

(57) ABSTRACT

A device and method for model estimation may be provided. The device (100) comprises a local model setting unit (106) configured to determine a function in response to receiving an input relating to a local model, the function corresponding to the local model; and a local model optimization unit (114) configured to optimize a parameter for model estimation based on a refined regularization term of the local model, the refined regularization term being refined by shape information of the local model relating to the received input so as to optimize the parameter for model estimation.

### TECHNICAL FIELD

The present disclosure relates to devices and methods for model estimation.

### BACKGROUND ART

Linear regression is an approach to model the relationship between a scalar response (or dependent variable) and one or more independent variables. Linear regression can be used to predict, forecast or reduce errors by training a predictive model to an observed data set of values of the dependent and independent variables. Applications of linear regression include trend estimation for business analytics, epidemiology such as estimating disease risks and preventing diseases, capital asset pricing models in finance, prediction of consumption spending, labour demand and supply and artificial intelligence machine learning.

### SUMMARY OF INVENTION

### Technical Problem

However, there are problems associated with linear regression. For example, linear regression is too simple to describe the majority of the potential relationships among variables in datasets collected from the real world. In such cases, linear regression provides poor predictions. To solve this problem, various methods with more complex models and their learning algorithms have been proposed.

One of the modern methods is Heterogeneous Mixture Learning (HML). It consists of sparse piecewise linear model and factorized asymptotic Bayesian Learning as a statistical model and its learning algorithm, respectively. HML has several good properties such as interpretability, high computational efficiency (scalability) and high expressive power towards complex datasets from the real world. However, HML assumes that the distribution of the prediction error as the Gaussian, that is a continuous distribution with a symmetric shape. It means HML does not always provide an optimal prediction for a response variable belong to the Poisson distribution, for example accident counts in a driver risk profiling, as it is a non-negative discrete distribution with an asymmetric shape. Therefore, HML needs some modification for an optimal prediction in profiling driver risk for evaluating accident.

A need therefore exists to provide a device and method for model estimation that seeks to address at least some of the above problems.

### Solution to Problem

According to a first aspect of the present invention, there is provided a device for model estimation comprising: a local model setting unit configured to determine a function in response to receiving an input relating to a local model, the function corresponding to the local model; and a local model optimization unit configured to optimize a parameter for model estimation based on a refined regularization term of the local model, the refined regularization term being refined by shape information of the local model relating to the received input so as to optimize the parameter for model estimation.

In an embodiment, the device may further comprise a variational probability computation unit configured to compute a variational probability of a latent variable using the refined regularization term.

In an embodiment, the device may further comprise a branch pruning unit configured to compute and set a latent state number based on the variational probability of the latent variable.

In an embodiment, the parameter for model estimation includes a criterion value.

In an embodiment, the device may further comprise an optimality determination unit configured to determine whether the criterion value has converged using the refined regularization term of the local model.

In an embodiment, the device may further comprise a hierarchical latent structure setting unit configured to determine the local model.

In an embodiment, the device may further comprise a gating function optimization unit configured to classify the parameter using the refined regularization term of the local model.

In an embodiment, a loop process in which the variational probability computation unit computes the variational probability of the latent variable, the branch pruning unit computes and sets the latent state number, the local model optimization unit optimizes the parameter, the gating function optimization unit classifies the parameter and the optimality determination unit determines whether the criterion value has converged is repeatedly performed until the optimality determination unit determines that the criterion value has converged.

In an embodiment, the variational probability computation unit comprises a regularization term computation unit for computing the refined regularization term based on the received input relating to the local model.

According to a second aspect of the present invention, there is provided a method for model estimation comprising: receiving an input relating to a local model, determining a function in response to receiving the input, the function corresponding to determining to the local model; and optimizing a parameter for model estimation based on a refined regularization term of the local model, the refined regularization term being refined by shape information of the local model relating to the received input so as to optimize the parameter for model estimation.

In an embodiment, the method may further comprise computing a variational probability of a latent variable using the refined regularization term; computing and setting a latent state number based on the variational probability of the latent variable; classifying the parameter using the refined regularization term of the local model; and determining whether the criterion value has converged using the refined regularization term of the local model.

In an embodiment, the method may further comprise computing the refined regularization term based on information of the local model.

### BRIEF DESCRIPTION OF DRAWINGS

The accompanying Figures, where like reference numerals refer to identical or functionally similar elements throughout the separate views and which together with the detailed description below are incorporated in and form part of the specification, serve to illustrate various embodiments and to explain various principles and advantages in accordance with a present embodiment, by way of non-limiting example only.

Embodiments of the invention are described hereinafter with reference to the following drawings, in which:

FIG. 1 shows a schematic diagram 100 illustrating the flow of information in a device for model estimation, according to an example embodiment.

FIG. 2 shows a schematic diagram 200 illustrating the flow of information in the hierarchical latent variable variational probability computation unit 110 of FIG. 1, according to an example embodiment.

FIG. 3A show a flow chart 300 illustrating a method for model estimation, according to an example embodiment.

FIG. 3B show a flow chart 300 illustrating a method for model estimation, according to an example embodiment.

FIG. 4 shows a schematic diagram of a computer device 400 suitable for realizing the device shown in FIG. 1, according to an example embodiment.

FIG. 5 shows an exemplary computing device 500 to realize a unit for the various units of the device as shown in FIG. 1, according to an example embodiment.

### DESCRIPTION OF EMBODIMENTS

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “identifying”, “authorizing”, “verifying” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses a device for performing the operations of the methods. Such device may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized device to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

In embodiments of the present invention, use of the term “unit” may mean a single computing device or at least a computer network of interconnected computing devices which operate together to perform a particular function. In other words, the unit may be contained within a single hardware unit or be distributed among several or many different hardware units.

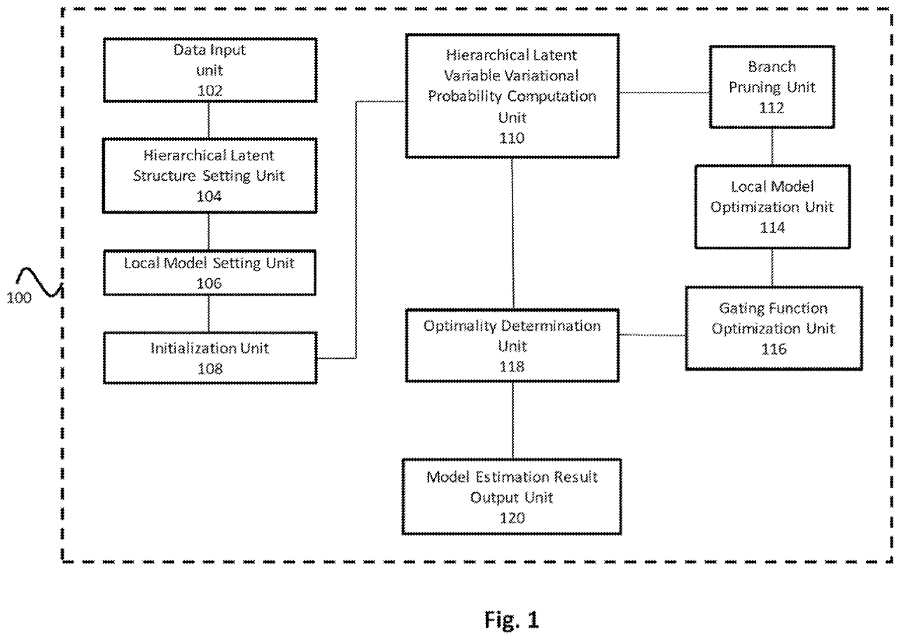

FIG. 1 shows a schematic diagram illustrating the flow of information in a device 100 for model estimation, according to an example embodiment. The device 100 includes a data input unit 102, a hierarchical latent structure setting unit 104, a local model setting unit 106, an initialization unit 108, a hierarchical latent variable variational probability computation unit 110, a branch pruning unit 112, a local model optimization unit 114, a gating function optimization unit 116, an optimality determination unit 118 and a model estimation result output unit 120.

The device 100 receives data relating to a model via the data input unit 102. That is, the data input unit 102 may receive input that are captured or entered in the likes of image capturing devices or an input device. Input data may include parameters necessary for the local model estimation, for example the type of observation probability, number of components and a candidate value for the number of latent states. It may also include parameters for the hierarchical latent structures, such as the depth of binary trees. Alternatively, the data input unit 102 may also simultaneously input the parameters when receiving the input data. The local model may be a regression model such as a generalized linear regression with sparseness constrains. A generalized linear regression can accept the error distribution of most of exponential family, for example a Gaussian model, a Logistic model, a Poisson model or an Exponential model. It can be appreciated that other types of models are applicable based on a distribution of the received data.

The hierarchical latent structure setting unit 104 is configured to select and set a structure of a hierarchical latent variable model as an optimization candidate, from the received input data received from the data input unit 102 for the type of observation probability and the number of components. The latent structure used in the present invention may be a tree structure, having a set number of components and a depth value. The hierarchical latent structure setting unit 104 may store the selected hierarchical latent variable model structure in an internal memory. For example, in the case of a binary tree model (model in which each branch node has two branches) of a tree structure of depth 2, the hierarchical latent structure setting unit 104 selects a hierarchical latent structure having two first-level nodes and four second-level nodes (lowest-level nodes in this exemplary embodiment). In alternate embodiments, the latent structure may be a generic tree structure having three to four leaves in each level of depth.

The local model setting unit 106 is configured to operate with the hierarchical latent structure setting unit 104. In various embodiments the local model setting unit 106 is configured to determine a function corresponding to the local model based on the inputs received at the data input unit 102. This may be achieved when the local model setting unit 106 recognizes the organized data and information corresponding to a particular distribution of exponential family in each local model, and proceeds to determine the function corresponding to the distribution in local model. The organized data may include the mean μ, a Mean Function M(θ) and a link function g(T) of the local model. The function may be represented by A(θ), a second derivative of A(θ), Fisher Information matrix F corresponding to the local model or their numerical approximation. A probability density function of natural exponential family can be written as

f(y|θ)=h(y)exp(θ^{T}y−A(θ)),

such that A(θ) may contain shape information of the distribution. Further derivatives of A(θ), such as a second derivative of A, may indicate that the regularization term is refined by the shape information via the second derivative of A. In an example of the numerical approximation, if data x was scaled from −1 to 1, the variables xᵢ and xⱼ can be approximately replaced to 1. This may effectively contribute to computational efficiency. An example of the organized data and the function of some local models are shown below in table 1.

TABLE 1

| | | | MEAN | LINK | FISHER |
|---|---|---|---|---|---|
| | | | FUNCTION | FUNCTION | INFORMATION |
| MODELS | A(θ) | E[Y] | M(θ) | g(τ) | F_{i,,j} |
| Gaussian | $\frac{{θ}^{2}}{2}$ | μ | θ | τ | xᵢxⱼ |
| Logistic | log(1 + exp θ) | μ | $\frac{1}{1 + exp ( - θ )}$ | $log \frac{τ}{1 - τ}$ | ${x}_{i} {x}_{j} \frac{exp ( - x ϕ )}{{\{ 1 + exp ( - x ϕ ) \}}^{2}}$ |
| Poisson | exp θ | μ | exp θ | log τ | xᵢxⱼ exp(xϕ) |
| Exponential | −log(−θ) | $\frac{1}{λ}$ | $- \frac{1}{θ}$ | $- \frac{1}{τ}$ | $\frac{{x}_{i} {x}_{j}}{{( x ϕ )}^{2}}$ |

The initialization unit 108 is configured to perform an initialization process for estimating the hierarchical latent variable model. The initialization process is one that determines a model so as to better optimize the model. The initialization may be executed by an arbitrary method, such as a method of randomly setting the parameter θ of each observation probability, or a method of randomly setting the variational probability of the latent variable. For example, the initialization unit 108 may randomly set the type of observation probability for each component, and randomly set a parameter of each observation probability according to the set type. Moreover, the initialization unit 108 may randomly set a lowest-level path variational probability of a hierarchical latent variable.

The hierarchical latent variable variational probability computation unit 110 is configured to compute a variational probability of a path latent variable of the hierarchical latent structure using a refined regularization term. The parameter θ has been computed by the initialization unit 108 or by the branch pruning unit 112, the local model optimization unit 114 and the gating function optimization unit 116. Accordingly, the hierarchical latent variable variational probability computation unit 110 computes the variational probability using the parameter θ. The hierarchical latent variable variational probability computation unit 110 may also be configured to compute the variational probability by Laplace-approximating a marginal log-likelihood function with respect to an estimate (e.g. a maximum likelihood estimate or a maximum a posteriori probability estimate) for the complete variable and maximizing its lower bound. An optimization criterion A may represent factorized information criteria (FIC) of its tractable lower bound for hierarchical mixtures of expert (HME).

In detail, the maximization criterion A is a value that can be computed when parameters of lowest-level path latent variables and components are given. A marginal log-likelihood is given by the following Expression 1:

$${FIC}_{LB} ( {y}^{N} \vert {x}^{N} ) = {E}_{q ( z )} [ {\underbrace{log p ( {y}^{N} , {z}^{N} \vert {x}^{N} , θ )}}_{loglikelihood} + {R ( z )}_{regularization term} + {\underbrace{H ( q ( z ) )}}_{entropy} ] \qquad Expression 1$$

wherein the regularization term (or refined regularization term) may be defined as

$$R ( z ) = - {\sum }_{i = 1}^{G} \frac{{D}_{{β}_{i}}}{2} log {\sum }_{n = 1}^{N} {\sum }_{j ∈ {ϵ}_{j}} {z}_{j}^{( n )} - {\sum }_{j = 1}^{E} \frac{1}{2} {\sum }_{k = 1}^{{D}_{{ϕ}_{j}}} log {\sum }_{n = 1}^{N} {( {x}_{k}^{( n )} )}^{2} {A}^{″} ( {x}^{( n )} {ϕ}_{j}^{( t )} ) \qquad Expression 2$$

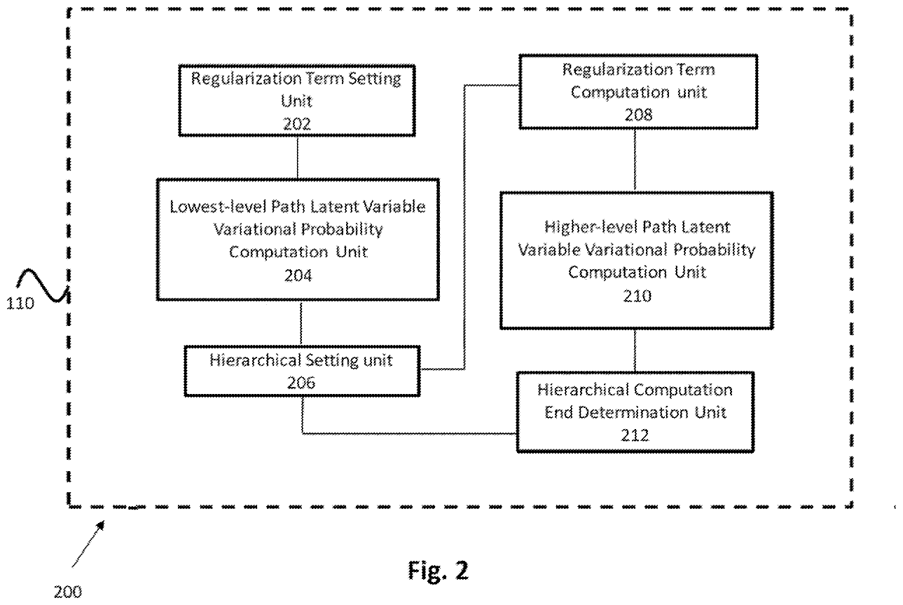

In the Expressions shown above, y denotes a response variable, x denotes an input variable, z denotes a latent variable and N denotes the number of samples. D_{ϕ}_{ⱼ} denotes the dimensionality of local regression model j, which may be advantageous to improve AI adaptation for machine learning. D_{β}_{ᵢ} denotes the dimensionality of gate function i while z, represents the j-th element of latent variable z. Further, E represents the number of experts, i.e. local regression models, and q(z) denotes the variational distribution of latent variable z. ϕj represents parameters of local model j, βi denotes parameters of gate function i and ϕ denotes a set of parameters of local regression models. Further, β represents a set of parameters of binary gate functions and θ represents a set of model parameters, e.g. β and θ. Further, A″ denotes a second derivative of A(θ), which has information about the shape of the distribution, and may contribute mainly to the refinement of the regularization term. The detailed features and information flow of the hierarchical latent variable variational probability computation unit 110 will be described in FIG. 2.

The computed variational probability is transferred to the branch pruning unit 112 which is configured to compute and set a number of latent states based on the variational probability. In order to do so, the branch pruning unit 112 may compute the rank of F_{Φ}, defined in Expression 4 below. F_{Φ} is a block matrix of F_{ϕ}_{ⱼ} defined as Expression 4 shown below. One of the possible algorithms to compute the rank of F is to count the number of singular values σ₁≥σ₂≥ . . . ≥σ_{K}_{^{(t-1)}} of F_{Φ} with the singular value decomposition (SVD) algorithm. The latent state number (equals to the rank of F) is then set by the branch pruning unit 112 using the following Expression 3:

K^{(t)}=max(K′)K^{t}|σ_{K}_{^{t}}≥δ Expression 3

For example, σ₁=1, σ₂=0.9, σ_{M}=0.1, σ_{K}_{^{(t-1)}}=0.0000001. IF the threshold delta δ=0.1, therefore K′={1, 2, . . . M} and K^{(t)}=max(K′)=M.

$${F}_{Φ} = [ \begin{matrix}{F}_{{ϕ}_{1}} & 0 & 0 & 0 \\ 0 & {F}_{{ϕ}_{2}} & 0 & 0 \\ 0 & 0 & ⋱ & 0 \\ 0 & 0 & 0 & {F}_{{ϕ}_{{K}^{( t - 1 )}}}\end{matrix} ] \qquad Expression 4$$

$${F}_{{ϕ}_{j}} = [ \begin{matrix}{F}_{{ϕ}_{j}}^{( 1 , 1 )} & {F}_{{ϕ}_{j}}^{( 1 , 2 )} & … & {F}_{{ϕ}_{j}}^{( 1 , {D}_{{ϕ}_{j}} )} \\ {F}_{{ϕ}_{j}}^{( 2 , 1 )} & {F}_{{ϕ}_{j}}^{( 2 , 2 )} & … & ⋮ \\ ⋮ & ⋮ & ⋱ & ⋮ \\ {F}_{{ϕ}_{j}}^{( {D}_{{ϕ}_{j}} , 1 )} & … & … & {F}_{{ϕ}_{j}}^{( {D}_{{ϕ}_{j}} , {D}_{{ϕ}_{j}} )}\end{matrix} ]$$

$${F}_{{ϕ}_{j}}^{( t , m )} ≡ \frac{1}{N} {\sum }_{n = 1}^{N} {x}_{t}^{( n )} {x}_{m}^{( n )} {A}^{″} ( {x}_{k}^{( n )} {ϕ}_{j}^{T} )$$

The local model optimization unit 114 optimizes a parameter for model estimation based on the refined regularization term of the local model. The parameter may include a criterion value and may be optimised using the Expression 5 as follows:

$${ϕ}_{j}^{( t )} = arg {max}_{{ϕ}_{j}} {\sum }_{n = 1}^{N} {q}^{( t )} ( {z}_{j}^{( n )} ) log p ( {y}^{( n )} \vert {x}^{( n )} , {ϕ}_{j} ) - \frac{1}{2} log {\sum }_{k = 1}^{{D}_{{ϕ}_{j}}} {\sum }_{n = 1}^{N} {( {x}_{k ,}^{( n )} )}^{2} {A}^{″} ( {x}_{j}^{( n )} {ϕ}_{j} ) {q}^{( t - 1 )} ( {z}_{j}^{( n )} ) \qquad Expression 5$$

whereby the Expression is dependent on the local model. The parameters in Expression 5 have been defined above in Expressions 1 and 2.

The gating function optimization unit 116 then extracts a branch node list using the model estimated by the local model optimization unit 114. The gating function optimization unit 116 then selects one branch node from the extracted branch node list. Hereafter, the selected node is also referred to as a selection node. The gating function optimization unit 116 optimizes the branch parameter of the selection node, using the input data and the latent variable variational probability for the selection node obtained from the hierarchical latent variable variational probability. The branch parameter of the selection node corresponds to the above-mentioned gating function. The gating function optimization unit 116 then determines whether or not all branch nodes extracted have been optimized. In the case where all branch nodes have been optimized, the gating function optimization unit 116 ends the process. In the case where all branch nodes have not been optimized, the gating function optimization unit 116 repeats the processes. A specific example of the gating function is described below, using a gating function based on a Bernoulli distribution for a binary tree hierarchical model. Hereafter, the gating function is also referred to as a Bernoulli gating function. Let x_{d} be the d-th dimension of x, g⁻ be a probability of branching to the lower left of the binary tree when this value does not exceed a threshold w, and g⁺ be a probability of branching to the lower left of the binary tree when this value exceeds the threshold w. The gating function optimization unit 116 optimizes the above-mentioned optimization parameters d, w, g⁻, and g⁺, based on the Bernoulli distribution. In this case, each parameter has an analytical solution unlike the parameter based on a logit function of a typical hierarchical latent variable model, which contributes to faster optimization.

The optimality determination unit 118 is configured to determine whether the criterion value of the parameter has converged using the refined regularization term of the local model. As it would be appreciated, a better convergence means a lower probability of overfitting. The optimality determination unit 118 may do so by expanding the local model class to include an exponential family. The determination may be based on Expression 1 as described above.

More specifically, the optimality determination unit 118 determines whether or not the optimization criterion A computed using Expression 2 described above has converged. In the case where the optimization criterion A has not converged, the optimality determination unit 118 transmits a signal to the hierarchical latent variable variational probability computation unit 110 such that the processes by the hierarchical latent variable variational probability computation unit 110, the branch pruning unit 112, the local model optimization unit 114, the gating function optimization unit 106 and the optimality determination unit 118 are repeated. For example, the optimality determination unit 118 may determine that the optimization criterion A has converged in the case where an increment of the optimization criterion A is less than a predetermined threshold.

If the optimality determination unit 118 determines that the criterion value has converged, then the model estimation result output unit 120 outputs the computed model estimation result.

The model estimation result output device 120 may output the optimal number of hidden states, type of observation probability, parameter, variational distribution, and the like as the model estimation result output result, in the case where model optimization has been completed for the candidate of the hierarchical latent variable model structure set from the input candidates for the type of observation probability and the number of components. In the case where there is any candidate for which optimization has not been completed, on the other hand, the procedure goes to the process by the hierarchical latent structure setting unit 104, and the same processes as described above are performed.

A schematic diagram illustrating the flow of information in the hierarchical latent variable variational probability computation unit 110 is shown in FIG. 2. The hierarchical latent variable variational probability computation unit 110 includes a regularization term setting unit 202, a lowest-level path latent variable variational probability computation unit 204, a hierarchical setting unit 206, a regularization term computation unit 208, a higher-level path latent variable variational probability computation unit 210 and a hierarchical computation end determination unit 212. In an embodiment, an algorithm may be configured to execute the flow of information in the hierarchical latent variable variational probability computation unit 110. For example, the algorithm may be configured to update the latent variable (e.g. q(z)), update the number of components and update the parameters of gate functions optimization parameters (e.g. d, w, g⁻, and g⁺) and local regression models

(e.g ϕ)

until convergence.

The hierarchical latent variable variational probability computation unit 110 receives data relating to the local model hierarchical latent structure through the regularization term setting unit 202 which then sets a refined regularization term. The regularization term setting unit 202 may be configured to compute the sum of latent variable variational probabilities of the current level having the same branch node as the parent. Additionally, the regularization term setting unit 202 may be configured to set the sum as the path latent variable variational probability of the immediately higher level. The refined regularization term may contain higher derivatives of A(θ) (containing shape information of the distribution) indicating that the regularization term is refined by the shape information via the derivative of A. In particular, A(θ) may be a partition function such that it contains all the information about the distribution, including information on the shape of the distribution. The lowest-level path latent variable variational probability computation unit 204 then computes the variational probability of the lowest-path latent variable. The hierarchical setting unit 206 then organizes the data and the refined regularization term computation unit 208 computes the refined regularization term. The refined regularization term may include Expression 2 as described above.

The distribution of latent variables q(z) may be updated using Expression 6 below. More specifically, the Expression may update the distribution of latent variables from the parameters

ϕ

of the local model estimations of the distribution of latent variables in the previous loop, i.e. t−1. The parameters in Expression 6 have been defined above in Expressions 1 and 2 above.

$$q ( {z}_{j} ) ∝ \prod \text{?} {Ψ}^{( i , j , t - 1 )} ( {x}^{( n )} ) p ( {y}^{( n )} \vert {x}^{( n )} , {ϕ}_{j}^{i - 1} ) exp \{ \sum \text{?} \frac{- D \text{?}}{2 {\sum }_{n = 1}^{N} {\sum }_{j ∈ G} {q}^{( t - 1 )} ( {z}_{j}^{( n )} )} + \frac{- {D}_{{ϕ}_{j}}}{2 {\sum }_{k = 1}^{D} \text{?} log {\sum }_{n = 1}^{N} {( {x}_{k}^{( n )} )}^{2} {A}^{″} ( {x}^{( n )} {ϕ}_{j}^{( t - 1 )} ) {q}^{( t - 1 )} ( {z}_{j}^{( n )} )} \} \qquad Expression 6$$

$$\text{?} \text{indicates text missing or illegible when filed}$$

The higher-level path latent variable variational probability computation unit 210 subsequently computes the variational probability of the highest-path latent variable and the hierarchical computation end determination unit 212 then determines whether the computed variational probability of the highest-path latent variable is maximized. If it is determined that the computed variational probability of the highest-path latent variable is maximized, then the hierarchical computation end determination unit 212 outputs the computed variational probability. On the other hand, if the computed variational probability of the highest-path latent variable is not maximized, the hierarchical computation end determination unit 212 transmits a signal to the hierarchical setting unit 206 to repeat the process until the computed variational probability is determined to be maximized.

An example of the model estimation device is described. More specifically, an example of applying the model estimation device to a situation of assessing a driver's risk. By applying the model estimation device as described above, it is possible to decompose the relationship between an accident count and the driver risk and thus obtain a better assessment of the driver's risk. Moreover, by applying the model estimation device, it is possible to estimate a rule of switching between the acquired plurality of relations, such as relations between driver risk and accident count, driver risk and occupation, driver risk and weather or driver risk and date. For driver risk prediction, it is important to not only estimate the plurality of relations but also estimate how to switch between the plurality of relations. For example, consider a hierarchical latent variable model in which an assumed polynomial regression expression having at least one of air temperature, time of day, and day of week as explanatory variables and driver risk after one hour as a response variable is applied to each component. A model to be estimated here is a hierarchical latent structure, a regression parameter and a lowest-level path latent variable variational distribution. First, the data input device 102 inputs a plurality of different tree structures as hierarchical latent structure candidates to the model estimation device, together with the data of the explanatory variables and the response variable. The hierarchical latent structure setting unit 104 sets the input tree structures in sequence. Next, the initialization unit 108 randomly sets a regression degree and other parameters for the set hierarchical latent structure, as the initialization process. The model is then estimated through the processes by the hierarchical latent variable variational probability computation unit 110 to the optimality determination unit 118. By these processes, a plurality of regression models representing different circumstances and their switching rule can be obtained automatically. Examples of the plurality of regression models representing the different circumstances include a regression model having a large regression coefficient of an explanatory variable indicating about 9 o'clock which is the time where rush-hour traffic occurs, and a regression model having a relatively small regression coefficient of a parameter indicating the time of day. Furthermore, the local model optimization unit 114 may be configured to select which hierarchical latent structure is optimal. Hence, it is possible to, for example, automatically detect the number of different power consumption patterns according to the driver and model the relations of the appropriate number of patterns and their switching rule.

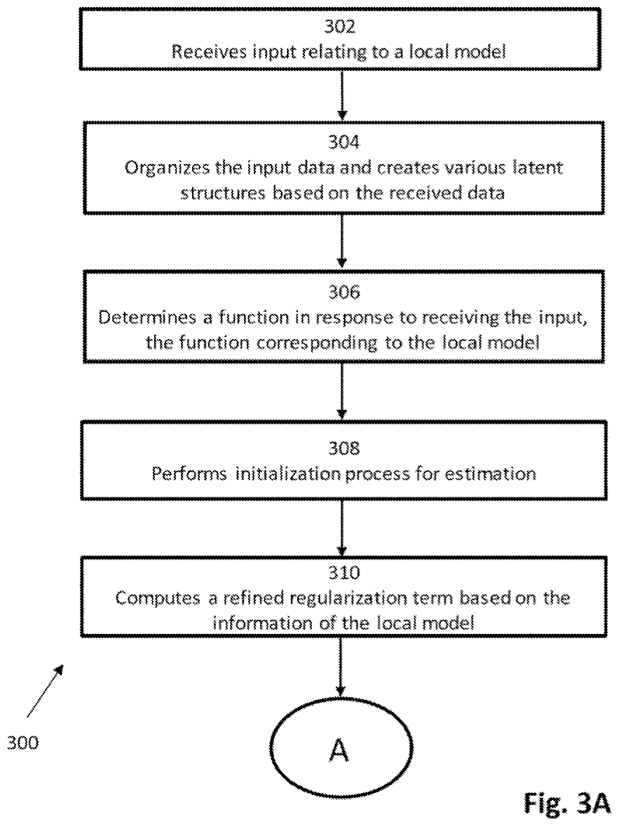

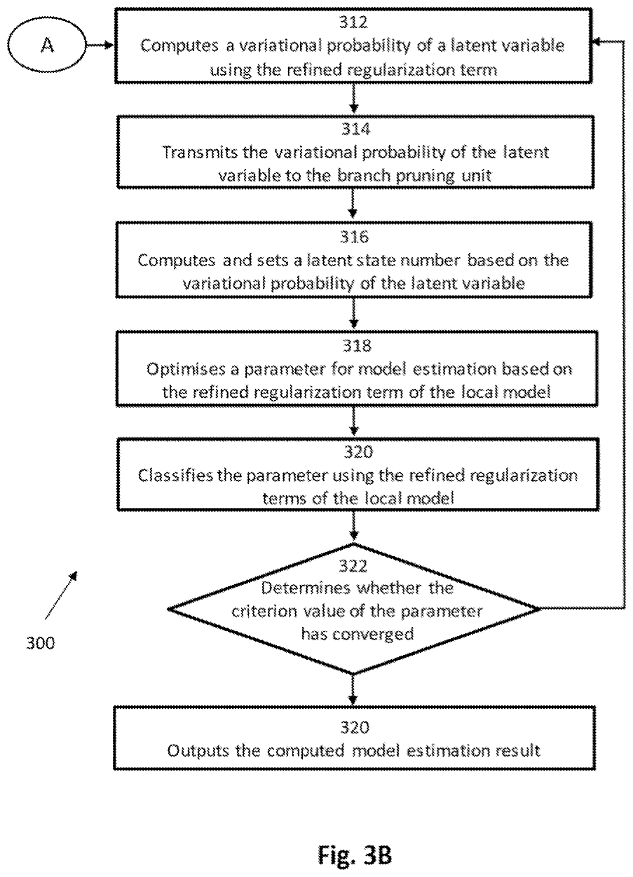

FIGS. 3A and 3B show a flow chart illustrating a method for model estimation, according to an example embodiment. At step 302, the device 100 receives an input relating to a local model via the data input unit 102. At step 304, hierarchical latent structure setting unit 104 organizes the data and creates various latent structures based on the received data. At step 306, the local model setting unit 106 determines a function in response to receiving the input, the function corresponding to the local model. At step 308, the initialization unit 108 performs an initialization process for estimation. At step 310, the hierarchical latent variable variational probability computation unit 110 computes a refined regularization term based on the information of the local model and at step 312, further computes a variational probability of a latent variable using the refined regularization term. The variational probability of the latent variable is then transmitted to the branch pruning unit 112 at step 314.

At step 316, the branch pruning unit 112 computes and sets a latent state number based on the variational probability of the latent variable. At step 318, the local model optimization unit 114 optimises a parameter for model estimation based on the refined regularization term of the local model, the parameter including a criterion value. At step 320, the gating function optimization unit 116 classifies the parameter from the local model optimization unit 114 using the refined regularization term of the local model. At step 322, optimality determination unit 118 determines whether the criterion value of the parameter has converged using the refined regularization term of the local model. If the optimality determination unit 118 determines that the criterion value of the parameter has converged, then the model estimation result output unit 120 outputs the computed model estimation result at step 320. On the other hand, if the criterion value has not converged, the optimality determination unit 118 transmits a signal to the hierarchical latent variable variational probability computation unit 110 to repeat the process from step 310 until the criterion value has converged.

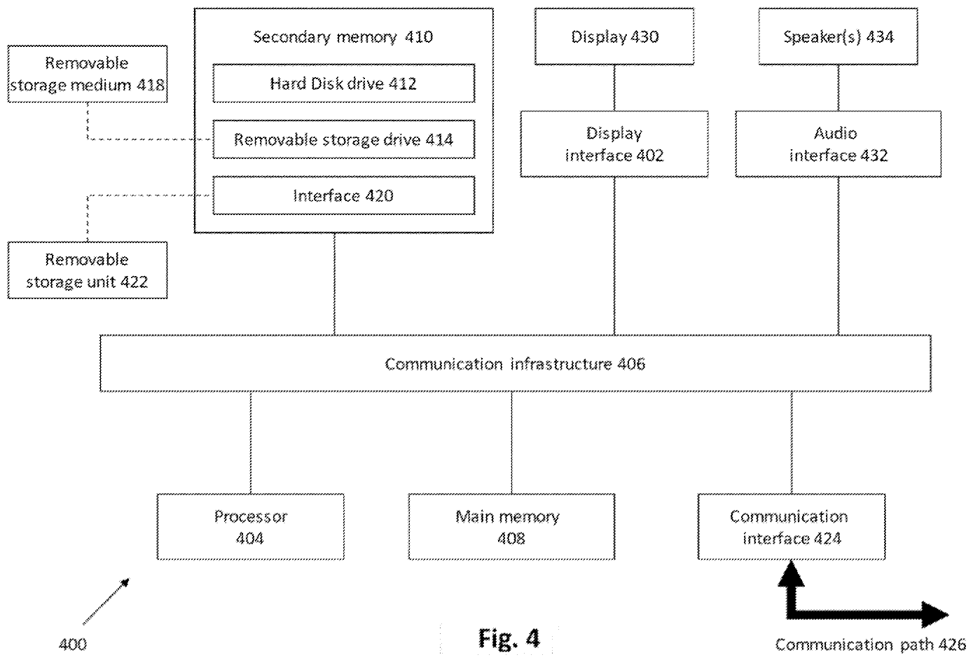

Use of the term “device” herein may be understood to mean a single computing device or a plurality of interconnected computing devices which operate together to perform a particular function. That is, the unit may be contained within a single hardware unit or be distributed among several different hardware units. An exemplary computing device which may be operated as a device is described below with reference to FIG. 4.

FIG. 4 shows a schematic diagram of a computer device or computer system 400 suitable for realizing the device 100 of FIG. 1. The following description of the computing device 400 is provided by way of example only and is not intended to be limiting.

As shown in FIG. 4, the example computing device 400 includes a processor 404 for executing software routines. Although a single processor is shown for the sake of clarity, the computing device 400 may also include a multi-processor system. The processor 404 is connected to a communication infrastructure 406 for communication with other components of the computing device 400. The communication infrastructure 406 may include, for example, a communications bus, cross-bar, or network.

The computing device 400 further includes a main memory 408, such as a random access memory (RAM), and a secondary memory 410. The secondary memory 410 may include, for example, a hard disk drive 412, which may be a hard disk drive, a solid state drive or a hybrid drive and/or a removable storage drive 414, which may include a magnetic tape drive, an optical disk drive, a solid state storage drive (such as a USB flash drive, a flash memory device, a solid state drive or a memory card), or the like. The removable storage drive 414 reads from and/or writes to a removable storage unit 418 in a well-known manner. The removable storage unit 418 may include magnetic tape, optical disk, non-volatile memory storage medium, or the like, which is read by and written to by removable storage drive 414. As will be appreciated by persons skilled in the relevant art(s), the removable storage unit 418 includes a computer readable storage medium having stored therein computer executable program code instructions and/or data.

In an alternative implementation, the secondary memory 410 may additionally or alternatively include other similar means for allowing computer programs or other instructions to be loaded into the computing device 400. Such means can include, for example, a removable storage unit 422 and an interface 420. Examples of a removable storage unit 422 and interface 420 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 422 and interfaces 420 which allow software and data to be transferred from the removable storage unit 422 to the computer system 400.

The computing device 400 also includes at least one communication interface 424. The communication interface 424 allows software and data to be transferred between computing device 400 and external devices via a communication path 426. In various embodiments, the communication interface 424 permits data to be transferred between the computing device 400 and a data communication network, such as a public data or private data communication network. The communication interface 424 may be used to exchange data between different computing devices 400 which such computing devices 400 form part an interconnected computer network. Examples of a communication interface 424 can include a modem, a network interface (such as an Ethernet card), a communication port (such as a serial, parallel, printer, GPIB, IEEE 1394, RJ45, USB), an antenna with associated circuitry and the like. The communication interface 424 may be wired or may be wireless. Software and data transferred via the communication interface 424 are in the form of signals which can be electronic, electromagnetic, optical or other signals capable of being received by communication interface 424. These signals are provided to the communication interface via the communication path 426.

As shown in FIG. 4, the computing device 400 further includes a display interface 402 which performs operations for rendering images to an associated display 430 and an audio interface 432 for performing operations for playing audio content via associated speaker(s) 434.

As used herein, the term “computer program product” may refer, in part, to removable storage unit 418, removable storage unit 422, a hard disk installed in hard disk drive 412, or a carrier wave carrying software over communication path 426 (wireless link or cable) to communication interface 424. Computer readable storage media refers to any non-transitory tangible storage medium that provides recorded instructions and/or data to the computing device 400 for execution and/or processing. Examples of such storage media include magnetic tape, CD-ROM, DVD, Blu-ray™ Disc, a hard disk drive, a ROM or integrated circuit, a solid state drive (such as a USB flash drive, a flash memory device, a solid state drive or a memory card), a hybrid drive, a magneto-optical disk, or a computer readable card such as a PCMCIA card and the like, whether or not such devices are internal or external of the computing device 400. Examples of transitory or non-tangible computer readable transmission media that may also participate in the provision of software, application programs, instructions and/or data to the computing device 400 include radio or infra-red transmission channels as well as a network connection to another computer or networked device, and the Internet or Intranets including e-mail transmissions and information recorded on Websites and the like.

The computer programs (also called computer program code) are stored in main memory 408 and/or secondary memory 410. Computer programs can also be received via the communication interface 424. Such computer programs, when executed, enable the computing device 400 to perform one or more features of embodiments discussed herein. In various embodiments, the computer programs, when executed, enable the processor 404 to perform features of the above-described embodiments. Accordingly, such computer programs represent controllers of the computer system 400.

Software may be stored in a computer program product and loaded into the computing device 400 using the removable storage drive 414, the hard disk drive 412, or the interface 420. Alternatively, the computer program product may be downloaded to the computer system 400 over the communications path 426. The software, when executed by the processor 404, causes the computing device 400 to perform functions of embodiments described herein.

It is to be understood that the embodiment of FIG. 4 is presented merely by way of example. Therefore, in some embodiments one or more features of the computing device 400 may be omitted. Also, in some embodiments, one or more features of the computing device 400 may be combined together. Additionally, in some embodiments, one or more features of the computing device 400 may be split into one or more component parts.

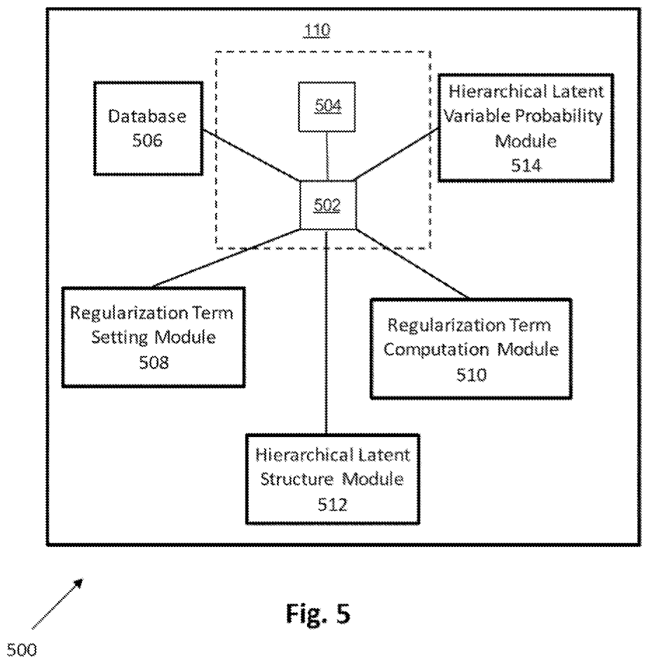

FIG. 5 shows an exemplary computing device 500 to realize a unit for the various units of the device as shown in FIG. 1, according to an example embodiment. More specifically, the computing device 500 may realize the data input unit 102, the hierarchical latent structure setting unit 104, the local model setting unit 106, the initialization unit 108, the hierarchical latent variable variational probability computation unit 110, the branch pruning unit 112, the local model optimization unit 114, the gating function optimization unit 116, the optimality determination unit 118 and the model estimation result output unit 120.

In an example embodiment, the hierarchical latent variable variational probability computation unit 110 shown in FIG. 5 may also include a database 506, a regularization term setting module 508, a regularization term computation module 510, a hierarchical latent structure module 512 and a hierarchical latent variable probability module 514. The memory 504 stores computer program code that the processor 502 compiles to have each of the database 506, the regularization term setting module 508, the regularization term computation module 510, the hierarchical latent structure module 512 and the hierarchical latent variable probability module 514 perform their respective functions. With reference to FIG. 2, the database 506 is configured to store refine regularization term. The regularization term setting module 508 is configured to set the refined regularization term based on the input data of the local model. The regularization term computation module 510 is configured to compute the refined regularization term while the hierarchical latent structure module 512 is configured to receive the hierarchical latent structure of the local model from the initialization unit 108. The hierarchical latent variable probability module 514 is configured to transmit the computed hierarchical latent variable probability to the branch pruning unit 112.

The system and method for model estimation as described above may provide optimal model estimation and can describe or correlate complex relationships between input and output variables.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

For example, the whole or part of the exemplary embodiments disclosed above can be described as, but not limited to, the following supplementary notes.

(Supplementary Note 1)

A device for model estimation comprising:

a local model setting unit configured to determine a function in response to receiving an input relating to a local model, the function corresponding to the local model; and
a local model optimization unit configured to optimize a parameter for model estimation based on a refined regularization term of the local model, the refined regularization term being refined by shape information of the local model relating to the received input so as to optimize the parameter for model estimation.

(Supplementary Note 2)

The device according to note 1, further comprising a variational probability computation unit configured to compute a variational probability of a latent variable using the refined regularization term.

(Supplementary Note 3)

The device according to note 2, further comprising a branch pruning unit configured to compute and set a latent state number based on the variational probability of the latent variable.

(Supplementary Note 4)

The device according to note 1, wherein the parameter for model estimation includes a criterion value.

(Supplementary Note 5)

The device according to note 4, further comprising an optimality determination unit configured to determine whether the criterion value has converged using the refined regularization term of the local model.

(Supplementary Note 6)

The device according to note 1, further comprising a hierarchical latent structure setting unit configured to determine the local model.

(Supplementary Note 7)

The device according to note 1, further comprising a gating function optimization unit configured to classify the parameter using the refined regularization term of the local model.

(Supplementary Note 8)

The device according to any one of notes 1 to 7, wherein a loop process in which the variational probability computation unit computes the variational probability of the latent variable, the branch pruning unit computes and sets the latent state number, the local model optimization unit optimizes the parameter, the gating function optimization unit classifies the parameter and the optimality determination unit determines whether the criterion value has converged is repeatedly performed until the optimality determination unit determines that the criterion value has converged.

(Supplementary Note 9)

The device according to note 1, wherein the variational probability computation unit comprises a regularization term computation unit for computing the refined regularization term based on the received input relating to the local model.

(Supplementary Note 10)

A method for model estimation comprising:

receiving an input relating to a local model,
determining a function in response to receiving the input, the function corresponding to determining to the local model; and
optimizing a parameter for model estimation based on a refined regularization term of the local model, the refined regularization term being refined by shape information of the local model relating to the received input so as to optimize the parameter for model estimation.

(Supplementary Note 11)

The method of note 10, wherein the parameter for model estimation includes a criterion value

(Supplementary note 12)

The method according to note 10 or 11, further comprising:

computing a variational probability of a latent variable using the refined regularization term;
computing and setting a latent state number based on the variational probability of the latent variable;
classifying the parameter using the refined regularization term of the local model; and
determining whether the criterion value has converged using the refined regularization term of the local model.

(Supplementary Note 13)

The method according to any one of notes 10 to 12, wherein a loop process in which computing the variational probability of the latent variable, computing and setting the latent state number, optimizing the parameter, classifying the parameter and determining whether the criterion value has converged is repeatedly performed until the criterion value converges.

(Supplementary note 14)

The method according to any one of notes 10 to 13, further comprising computing the refined regularization term based on information of the local model.

This application is based upon and claims the benefit of priority from Singapore Patent Application No. 10202003373S, filed on Apr. 13, 2020, the disclosure of which is incorporated herein in its entirety by reference.

### REFERENCE SIGNS LIST

100 Device
102 Data Input unit
104 Hierarchical Latent Structure Setting Unit
106 Local Model Setting Unit
108 Initialization Unit
110 Hierarchical Latent Variable Variational Probability Computation Unit
112 Branch Pruning Unit
114 Local Model Optimization Unit
116 Gating Function Optimization Unit
118 Optimality Determination Unit
120 Model Estimation Result Output Unit
200 Diagram
202 Regularization Term Setting Unit
204 Lowest-level Path Latent Variable Variational Probability Computation Unit
206 Hierarchical Setting unit
208 Regularization Term Computation unit
210 Higher-level Path Latent Variable Variational Probability Computation Unit
212 Hierarchical Computation End Determination Unit
400 Device
402 Display interface
404 Processor
406 Communication infrastructure
408 Main memory
410 Secondary memory
412 Hard Disk drive
414 Removable storage drive
418 Removable storage medium
420 Interface
422 Removable storage unit
424 Communication interface
426 Communication path
430 Display
432 Audio interface
434 Speaker(s)
500 Device
502 Processor
504 Memory
506 Database
508 Regularization Term Setting Module
510 Regularization Term Computation Module
512 Hierarchical Latent Structure Module
514 Hierarchical Latent Variable Probability Module

What is claimed is:

1. A device for model estimation: wherein the device is configured to:
determine a function in response to receiving an input relating to a local model, the function corresponding to the local model; and
optimize a parameter for model estimation based on a refined regularization term of the local model, the refined regularization term being refined by shape information of the local model relating to the received input so as to optimize the parameter for model estimation.

2. The device according to claim 1, wherein the device is further configured to compute a variational probability of a latent variable using the refined regularization term.

3. The device according to claim 2, wherein the device is further configured to compute and set a latent state number based on the variational probability of the latent variable.

4. The device according to claim 1, wherein the parameter for model estimation includes a criterion value.

5. The device according to claim 4, wherein the device is further configured to determine whether the criterion value has converged using the refined regularization term of the local model.

6. The device according to claim 1, wherein the device is further configured to determine the local model.

7. The device according to claim 1, wherein the device is further configured to classify the parameter using the refined regularization term of the local model.

8. The device according to claim 3, wherein
the parameter for model estimation includes a criterion value;
a loop process is repeatedly performed until the criterion value has converged; and
the loop process includes:
computing the variational probability of the latent variable;
computing and setting the latent state number;
optimizing the parameter;
classifying the parameter; and
determining whether the criterion value has converged.

9. The device according to claim 1, wherein the device is further configured to compute the refined regularization term based on the received input relating to the local model.

10. A method executed by a computer for model estimation comprising:
receiving an input relating to a local model;
determining a function in response to receiving the input, the function corresponding to determining to the local model; and
optimizing a parameter for model estimation based on a refined regularization term of the local model, the refined regularization term being refined by shape information of the local model relating to the received input so as to optimize the parameter for model estimation.

11. The method of claim 10, wherein the parameter for model estimation includes a criterion value.

12. The method according to claim 10, further comprising:
computing a variational probability of a latent variable using the refined regularization term;
computing and setting a latent state number based on the variational probability of the latent variable;
classifying the parameter using the refined regularization term of the local model; and
determining whether the criterion value has converged using the refined regularization term of the local model.

13. The method according to claim 12, wherein
the parameter for model estimation includes a criterion value;
a loop process is repeatedly performed until the criterion value converges; and
the loop process includes:
computing the variational probability of the latent variable;
computing and setting the latent state number;
optimizing the parameter;
classifying the parameter; and
determining whether the criterion value has converged.

14. The method according to claim 10, further comprising computing the refined regularization term based on information of the local model.

15. A non-transitory computer-readable medium storing a model estimation program that causes a computer to:
receive an input relating to a local model;
determine a function in response to receiving the input, the function corresponding to determining to the local model; and
optimize a parameter for model estimation based on a refined regularization term of the local model, the refined regularization term being refined by shape information of the local model relating to the received input so as to optimize the parameter for model estimation.
